(19) United States
(12) Patent Application Publication
(10) Pub. No.: US 2003/0008192 A1
(43) Pub. Date: Jan. 9, 2003

(54) Actuatable and reversible pressure generation based on fuel cell operation

(76) Inventors: Michael S. Freund, Sierra Madre, CA (US); Yu-Chong Tai, Pasadena, CA (US); Colin Cameron, Altadena, CA (US); Xing Yang, Pasadena, CA (US)

Correspondence Address: FISH & RICHARDSON, PC, 4350 LA JOLLA VILLAGE DRIVE, SUITE 500, SAN DIEGO, CA, 92122, US

(21) Appl. No.: 10/121,030

(22) Filed: Apr. 10, 2002

Related U.S. Application Data
(60) Provisional application No. 60/282,951, filed on Apr. 10, 2001.

(51) Int. Cl. H01M 8/10; H01M 8/18; H01M 2/08; H01M 4/96; C25B 1/10

(52) U.S. Cl. 429/37; 429/33; 429/44; 429/21; 429/35; 429/17; 205/628

(57) ABSTRACT

A fuel cell is used to create pressure by reverse biasing the fuel cell. A voltage is applied across the fuel cell to change the liquid near the fuel cell into gas, and expand its volume. The volume expansion is used for work function, either to expand a housing or move a piston or the like. By removing the voltage, the fuel cell can regenerate by absorbing the gas to again create energy, thereby retracting the volume expansion. In an embodiment, water may be the electrolyte which is electrolyzed to form hydrogen and oxygen gas, and then recombined into water.

### CROSS-REFERENCE TO RELATED APPLICATIONS

This application claims benefit of U.S. Provisional Application No. 60/282,951, filed Apr. 10, 2001.

### BACKGROUND

Many pressure producing elements use a moving part to create a pressure increase. The use of a moving part may produce drawbacks, especially in difficult operating conditions. Recently there has been considerable interest in the development of materials to convert electrical energy directly to mechanical energy and a number of new actuating materials are being developed to this end. These include electrochemically responsive conducting polymers, capacitance-driven carbon nanotube actuators, pH responsive hydrogels, ionic polymer metal composites, electric field responsive elastomers, and field electrostrictive polymers. An impetus behind this development is the desire to create more efficient transduction which can be scaled to size or weight demands that cannot be fulfilled by conventional electric motors, pumps, and switches. These constraints are particularly relevant to the emerging fields of microfluidics, microelectromechanical systems (MEMS), and robotics. While many of the new materials under investigation exhibit useful specific properties, e.g., large stresses, sizable strains, or fast cycling time, they commonly suffer from inherent limitations that severely restrict their general applicability.

### SUMMARY

According to the present system, an electrically operable cell, one without moving parts, is disclosed. This device uses electrolytic phase transformation. This system may use electrochemically generated gas for the reversible and controllable application of pressure and/or motion as used for actuation. In an embodiment, the device uses high surface area electrodes for rapid electrochemical response, and the separation of the electrochemical half reactions, as in, for example, a fuel cell, for full control of the volume and pressure change processes. In an embodiment, the cell is constructed in a flexible housing, as in a membrane, for direct application of pressure/volume. Another embodiment uses a rigid housing for the external direction of the pressure/volume changes by fluid flow in or out of the cell via tubing.

### BRIEF DESCRIPTION OF THE DRAWINGS

These and other aspects will now be described in detail with reference to the accompanying drawings, wherein:

FIGS. 1 and 2 show a flexible walled embodiment the pressure generating device, respectively in its deenergized and energized states; and

FIG. 3 shows a rigid walled device being used to drive an external device, e.g. a piston; and

FIGS. 4 and 5 show representative results.

### DETAILED DESCRIPTION

The present system describes a fuel cell configured for electrolytic generation of gas from a liquid. The generation of gas from the liquid may produce volume/pressure changes. According to the present system, the volume may change theoretically by large factors. In addition, the process is reversible, that is the gas can be recombined into a liquid, and occurs at a controlled rate.

Rapid recombination of gases is facilitated by electrodes having large effective catalyst surface area. Control of the recombination is achieved by physically separating the half reactions. Both conditions are present in fuel cells, that are well-known in the art. A common fuel cell configuration separates the two half-reactions by an ionically conducting membrane.

The present application operates by repeatedly running a cell, e.g. a electrochemically-reacting cell such as a fuel cell, “in reverse, that is to generate the necessary gases electrolytically, for the forward or generating portion of the cycle. This occurs in a 3:2 stoichiometric ratio of gas to liquid.

Specifically, for a hydrogen-oxygen electrochemical reaction:

2H₂O(l)⇄O₂(g)+4H⁺(aq)+4e⁻ (1)

4H (aq)+4e⁻⇄2H₂(g) (2)

Net: 2H₂O(l)⇄O₂(g)+2H₂(g) (3)

The fuel cell may then be operated in the conventional way to consume the gas, and return the system to its initial state. In this part of the operation, some energy may be recouped.

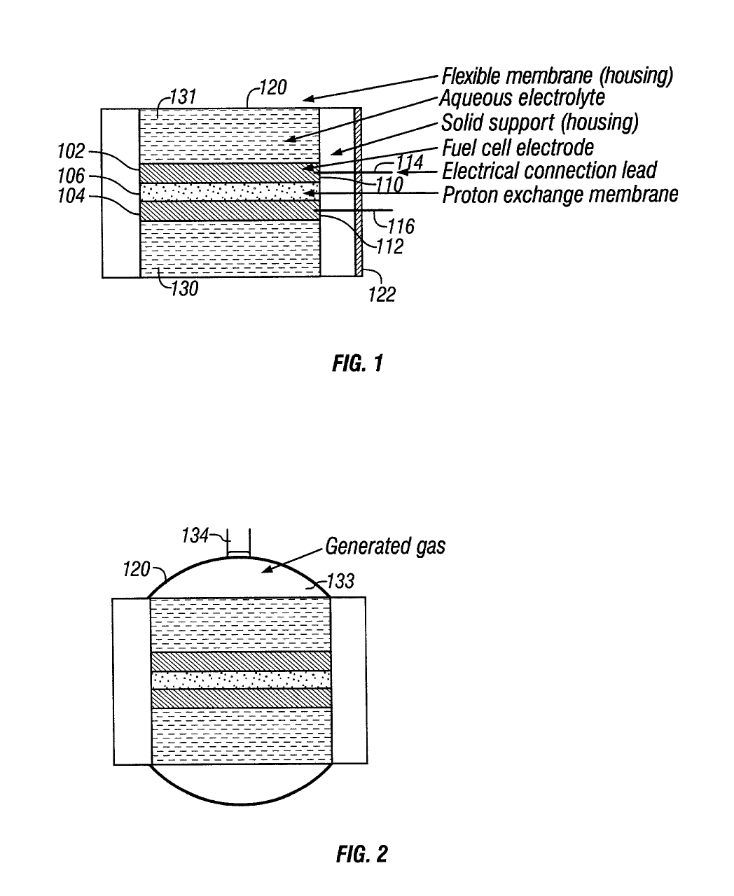

A reversible actuator, according to an embodiment, is shown in FIGS. 1, 2, and 3. Platinum impregnated carbon cloth fuel cell electrodes 102, 104 (e.g. as from Etech, Inc.) are held against a Nafion 117 proton exchange membrane 106 by perforated steel mesh elements 110, 112, which also provide electrical contact to the electrodes 102, 104. Wires 114, 116 connect the the mesh elements to contact the electrodes. Additional steel or platinum wire electrodes may be fitted and selected via an external control mechanism, for example, electrical relays. The cell is fitted within a flexible membrane housing 120 are shown in FIGS. 1 and 2. In an alternative embodiment, the housing is a rigid housing with fluid connectors running in parallel to prevent differential pressure buildup between the two compartments.

The compartments 130, 131 are filled with an aqueous electrolyte solution that may be comprised of 1 molar sulphuric acid or a phosphate buffer. The cell assembly is sealed either by an epoxy seal 122 or by a rubber gasket.

FIG. 2 shows how the result of the electrochemical reaction causes generated gas within the compartments 131, 130. This causes the flexible wall 120 to expand in the area 133. This expansion may itself be used for work, or may be used for sealing an orifice such as 134.

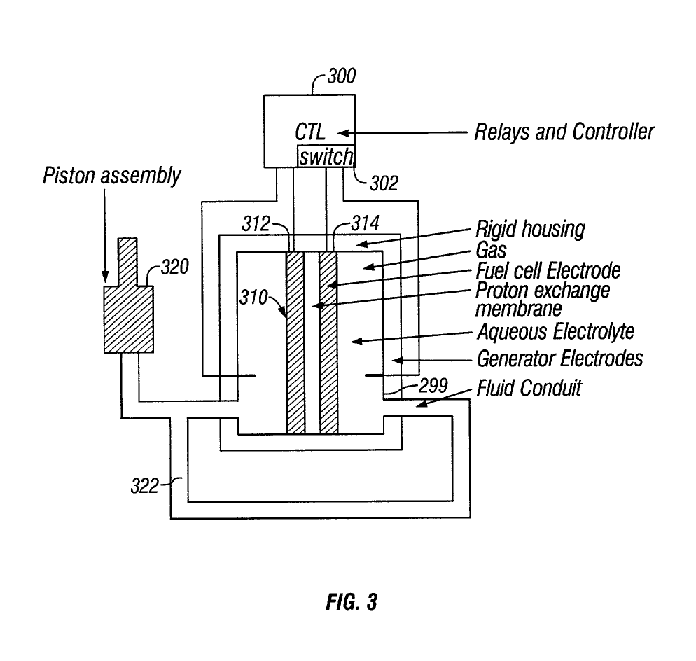

The device embodiment with a rigid housing 299 is shown with its control system in FIG. 3. The operation of the actuator may be computer controlled by controller 300, which may include relays 302 or switches therein. The fuel cell 310 is operated in electrolysis mode or in recombination mode by configuring relays 302 to apply a current across electrodes 312, 314 or to draw a current from electrodes 312, 314, respectively. In electrolysis mode, the applied current causes water in the cell to be converted to hydrogen at the cathode, and to oxygen at the anode.

The generation of gas increases the pressure and/or volume in the cell. In the FIGS. 1 and 2 embodiment, this causes the expansion of the flexible membrane 120 to the shape shown in FIG. 2. In the FIG. 3 embodiment, this causes the application of fluid force and motion through fluid conduits 322 to, for example, a piston 320. An applied potential of 3V may be sufficient under moderate conditions. In recombination mode, a lower applied voltage, or short circuit, between the fuel cell electrodes leads to the oxidation of hydrogen and reduction of oxygen to water. Current flows through the cell as the gases are consumed, and the rate of the process is controlled by the external electrical circuit.

The consumption of gas continues until the device has returned to its initial condition.

Since an actuator device based on these reactions is powered by the gas it generates, its response will be governed approximately by the ideal gas law:

PV=nRT (4)

The relationship provides two limiting scenarios:

(A) Expansion under isobaric conditions: This represents the maximum fractional change in length ΔL/L, or strain, that can be achieved in the form of linear displacement of a piston as the volume of the system grows. The charge passed during electrolysis and the reaction stoichiometry determine the volume of gas produced. The maximum strain that can be achieved with a piston driven by this process is a function of the volume of gas produced (equation 5) and the volume of water consumed (equation 6).

At constant pressure,

V_{gas}=(3/2)nH₂ORT/ρ (5)

V_{liquid}=nH₂O×MH₂O/ρH₂O (6)

Where MH₂O and ρH₂O are the molecular weight and density of water respectively, and nH₂O moles of water are transformed. The maximum relative strain under ambient conditions can be calculated:

$$\begin{matrix}strain = \frac{( actuated length ) - ( unactuated length )}{( unactuated length )} & ( 7 ) \\ = \frac{{V}_{gas} - {V}_{liquid}}{{V}_{liquid}} & ( 8 ) \\ ≅ \frac{{V}_{gas}}{{V}_{liquid}} & ( 9 ) \\ = \frac{( 3 / 2 ) RT / {ρ}_{atm}}{{M}_{{H}_{2} O} / {ρ}_{{H}_{2} O}} \\ ≅ 136 , 000 \% & ( 10 )\end{matrix}$$

(B) Pressurization at constant volume: The buildup of pressure within the system by electrolysis represents the maximum force per cross-sectional area, or stress, that can be generated and applied through a piston. In the absence of piston motion (and flex in the system components), the maximum stress is reached when the gas is confined to the small volume made available by the water consumed (see equation 6):

$$\begin{matrix}P = \frac{( 3 / 2 ) {n}_{{H}_{2} O} RT}{{V}_{liquid}} & ( 11 ) \\ = \frac{( 3 / 2 ) RT}{{M}_{{H}_{2} O} / {ρ}_{{H}_{2} O}} \\ ≅ 200 MPa & ( 12 )\end{matrix}$$

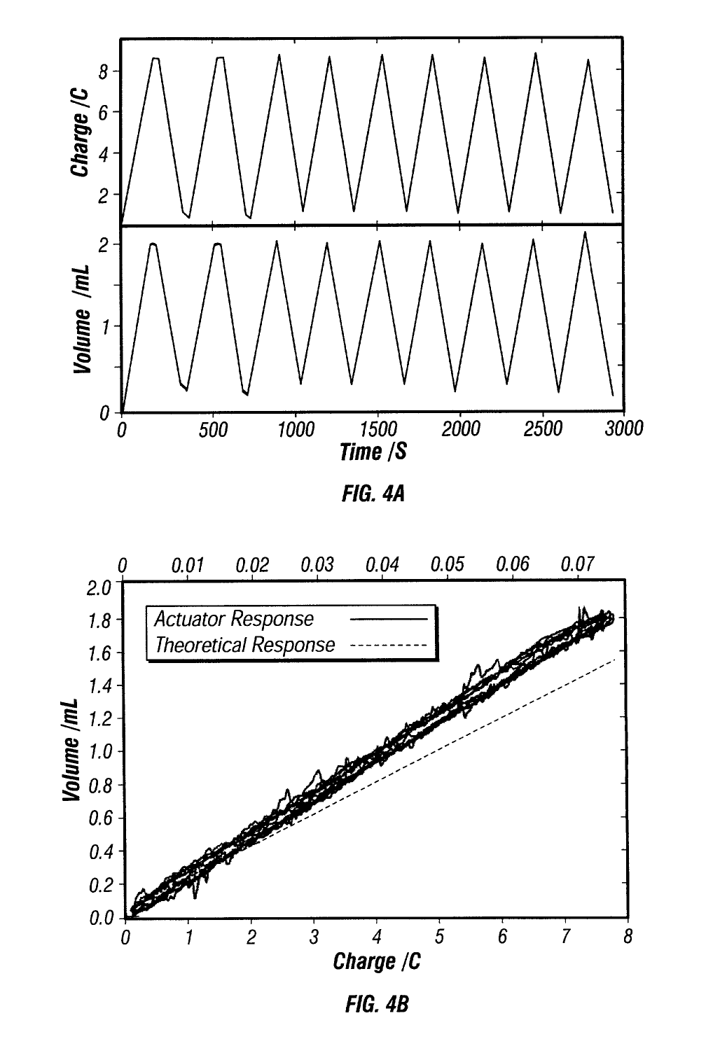

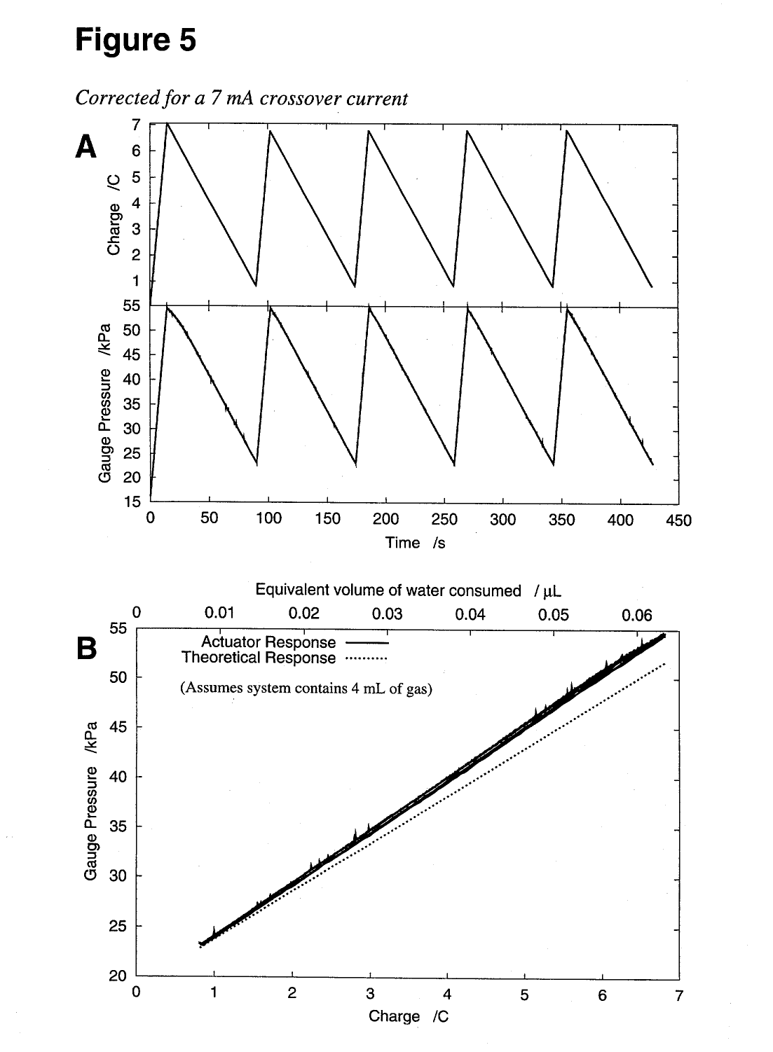

The performance of the device has been demonstrated under these two limiting conditions. In both cases, it was shown that the device behaves in accordance with the predicted response indicated above within experimental error. Representative results are presented in FIG. 4 for stress and in FIG. 5 for strain.

Although only a few embodiments have been disclosed in detail above, other modifications are possible. All such modifications are intended to be encompassed within the following claims.

What is claimed is:

1. A pressure producing part, comprising:
an electrochemically-reacting cell device, formed with a movable pressure accepting part which has a part that accepts pressure changes and which increases in size when actuated and decreases in size when deactuated; and
first and second electrodes leads, associated with said cell device, and connected electrically between the anode and cathode of said cell device.

2. A part as in claim 1, further comprising an electrical source, connected to said first and second electrode leads and controlled between a first voltage which produces a pressure increase, and a second lower voltage which produces a pressure decrease.

3. A part as in claim 1, wherein said fuel cell device is a carbon based cell device.

4. A part as in claim 3, wherein said carbon based fuel cell device includes an ionically conducting membrane, and a carbon based fuel cell electrode, sandwiched on alternate sides of said ionically conducting membrane.

5. A part as in claim 4, wherein said ionically conducting membrane includes Nafion.

6. A part as in claim 4, further comprising a nylon mesh, surrounding said carbon based fuel cell electrodes.

7. A part as in claim 1, wherein said pressure accepting part includes a flexible outer membrane.

8. A part as in claim 1, wherein said anode and cathode are catalyst impregnated, carbon cloth electrodes.

9. A part as in claim 3, wherein said pressure accepting part comprises a piston.

10. A part as in claim 1, wherein said pressure accepting part comprises an output port, providing pressurized fluid.

11. A method, comprising:
first operating an electrochemical cell device by applying a voltage across the anode and cathode of the cell device to generate gas; and
second operating said cell device, by recombining the gas to liquid, by reversing a voltage across the anode and cathode.

12. A method as in claim 11, wherein said reversing a voltage comprises short-circuiting across the anode and cathode.

13. A method as in claim 11, further comprising using said gas as a pressurized gas.

14. A method as in claim 11, further comprising using said gas to generate pressure during said first operating, and to relieve pressure during said second operating.

15. A method as in claim 11, further comprising increasing an interface area between the gas within the fuel cell and an electrolytic area of the fuel cell.

16. A method as in claim 15, wherein said increasing comprises surrounding said electrolytic area with a mesh material, to increase said interface.

17. A method as in claim 11, wherein said fuel cell device is a hydrogen/oxygen fuel cell device, and said first operating generates hydrogen and oxygen gas.

18. A fuel cell structure, comprising:
a first and second catalyst impregnated carbon cloth electrodes, respectively forming an anode and a cathode, and an ionically conducting membrane, separating said anode and cathode forming a membrane electrode assembly;
a first electrode connected to said anode, and a second electrode connected to said cathode;
a support structure for said membrane electrode assembly, having flexible surfaces, and having inner surfaces defining a chamber within which said membrane electrode assembly is located;
a sealing element for said membrane electrode assembly, sealing said membrane electrode assembly and allowing said first and second electrodes to extend between an outside of said support structure, and said membrane electrode assembly,
wherein said support structure flexible surfaces can be expanded and contracted by application of bias.

19. A fuel cell structure as in claim 18, further comprising a potential source, operating to apply bias to first and second electrodes, including a first bias level which causes expansion of said support structure, and a second bias level which causes contraction of said support structure.

20. A fuel cell structure as in claim 19, further comprising a mesh around said membrane electrode assembly.

21. A fuel cell structure as in claim 20, wherein said mesh is a nylon mesh.

22. A fuel cell structure as in claim 18, further comprising a liquid electrolyte within said support structure.

23. A fuel cell structure as in claim 22, wherein said liquid electrolyte is an aqueous phosphate buffer.

24. A fuel cell structure as in claim 19, wherein an outer surface of said membrane electrode assembly presses against an inner surface of said support structure when said second bias level is applied.

25. A method, comprising:
energizing an electrochemical cell to cause gas expansion therefrom;
using said gas expansion to carry out a work function; and
deenergizing said electrochemical cell to regenerate the fuel cell by absorbing the gas.

26. A method as in claim 25, wherein said energizing comprises applying a voltage to electrodes of said fuel cell, and said deenergizing comprises short-circuiting across said electrodes.

27. A method as in claim 25, wherein said using comprises expanding a housing containing said fuel cell.

28. A method as in claim 25, wherein said using comprises moving a piston coupled to said fuel cell.
